(19) United States
(12) Patent Application Publication
(10) Pub. No.: US 2010/0083123 A1
(43) Pub. Date: Apr. 1, 2010

(54) SYSTEM AND METHOD FOR IDENTIFYING BIOGRAPHICAL SUBJECTS

(76) Inventor: Anthony Bodetti, Monroe, CT (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 12/561,660

(22) Filed: Sep. 17, 2009

Related U.S. Application Data
(60) Provisional application No. 61/101,981, filed on Oct. 1, 2008.

(51) Int. Cl. G06F 3/00

(52) U.S. Cl. 715/738

(57) ABSTRACT

A system and method for identifying subjects for biographies, including an Internet-based process implemented using web page based code. A website provides a literary process for recognizing individuals who are not famous but whose biographies may attract wide interest, and then identifying such individuals as subjects for literary works that are then created and published in association with the website.

### CROSS-REFERENCE TO RELATED APPLICATION

This application claims the benefit of U.S. Provisional Application No. 61/101,981, filed Oct. 1, 2008.

### FIELD OF THE DISCLOSURE

This disclosure relates generally to Internet-based nomination and selection websites. More particularly, the disclosure relates to service applications for providing an Internet-based literary process for recognizing individuals whose biographies may have wide interest.

### BACKGROUND OF THE DISCLOSURE

Many books and biographies have been written about famous or well-known individuals. Such famous individuals are commonly recognized for their impact on business, sports, entertainment, public service, academia, or some other aspects of life.

However, there are many more individuals who are not famous, but nevertheless have led extraordinary lives and have had an impact on numerous people around them. Such individuals often make a deep impression on those they directly interact with, but generally are not in the public eye. Accordingly, their stories are not told in the standard media, and clearly are not a subject for entertainment news, tabloids, celebrity gossip forums or the like.

Studies have been performed which indicate that each person will come into contact or be acquainted with approximately 10,000 people in their lifetime. The “ordinary people with extraordinary lives” (“OP/EL”), as referred to herein, are those people who generally make a positive impact on each of the people they meet. Typically they have positive human traits; for example, they are described as kind, caring, compassionate, selfless, sensitive, noble, nurturing, humble, determined, genuine, generous, fascinating, and the like. An OP/EL individual typically has a lifetime of accumulated notable, exemplary and inherently positive qualities, rather than a set of specific actions or accomplishments. Those who know them will generally refer to them by such attributes. He/She may be recognized only late in life as having led an exemplary or instructive life. A biography of such an individual could have wide appeal for readers, and be instructive and inspirational for many more people than the individual could meet directly or encounter in his/her lifetime, with beneficial effects continuing after the individual's death. It is possible for some younger individuals to be considered, but in order to do so, they must have truly led noteworthy and impressive lives given their comparative lifetime.

It is desirable to implement a process by which OP/EL may be identified and have their individual biographies published.

### SUMMARY OF THE DISCLOSURE

A system and method are provided for identifying biographical subjects. According to one aspect of the disclosure, an Internet-based literary process is provided for recognizing OP/EL individuals. Furthermore, in accordance with this process, these individuals become biographical subjects for literary works.

According to another aspect of the disclosure, computer software is used to implement the process. This software includes Internet web page based code which provides a user of the site a tool for identifying OP/EL individuals.

According to one aspect of the disclosure, a method for identifying a subject for a literary work (performed using a web site dedicated thereto, where the web site is hosted on a computer server) includes the steps of receiving a nomination from a user via the web site, and transmitting to the user making the nomination a profile questionnaire for obtaining information regarding the nominee. After the questionnaire is received, additional information is collected regarding the nominee from additional users. The web site is used to facilitate communication among a plurality of users, thereby collecting further information regarding the nominee. The suitability of the nominee as a subject of a literary work is evaluated, and a nominee is selected as the subject. Finally, an author is assigned to the subject to prepare the literary work.

The foregoing has outlined, rather broadly, the preferred features of the present disclosure so that those skilled in the art may better understand the detailed description of the disclosure that follows. Additional features of the disclosure will be described hereinafter that form the subject of the claims of the disclosure. Those skilled in the art should appreciate that they can readily use the disclosed conception and specific embodiment as a basis for designing or modifying other structures for carrying out the same purposes of the present disclosure and that such other structures do not depart from the spirit and scope of the disclosure in its broadest form.

### BRIEF DESCRIPTION OF THE DRAWINGS

FIGS. 1A and 1B are connected flowcharts showing a literary selection process including a candidate (biographical subject) selection process and an author selection process, in accordance with an embodiment of the disclosure.

FIG. 2 schematically illustrates a web site constructed according to an embodiment of the disclosure, with associated content, user inputs, and literary product.

FIG. 3 schematically illustrates a system for implementing a literary selection process, in accordance with an embodiment of the disclosure.

### DETAILED DESCRIPTION

According to embodiments of the disclosure, a system for identifying biographical subjects includes a hosted internet based website for viewer and user interface, also referred to herein as the ‘main service website’. It is understood that the main service website may permit a user to access and interface with the main service website and all associated features and functions thereof, from either a wired or wireless connection from a variety of electronic desktop or handheld devices, e.g. desktop or laptop PC, Palm Pilot, Blackberry, IPhone, cell phone, Smart PDA, and similar equipment and/or devices.

The main service website is an interactive website that includes many functions and features commonly found in interne based applications such as web logs (blogs), as well as user interface applications which allow for cross-communication, social networking and multimedia content within the main service website.

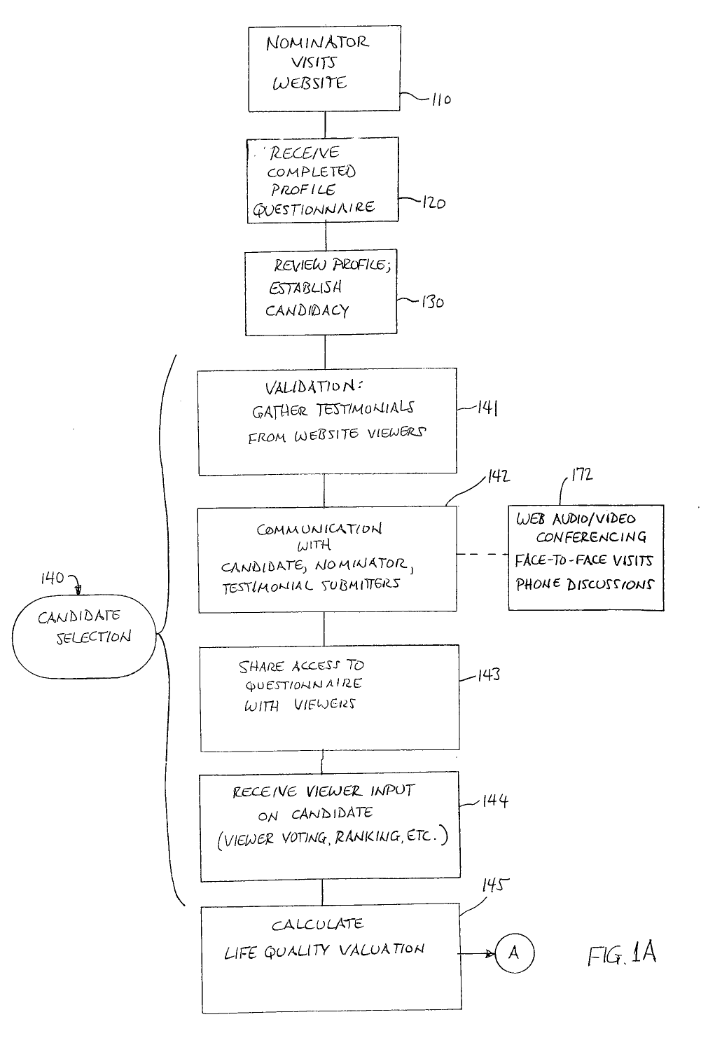

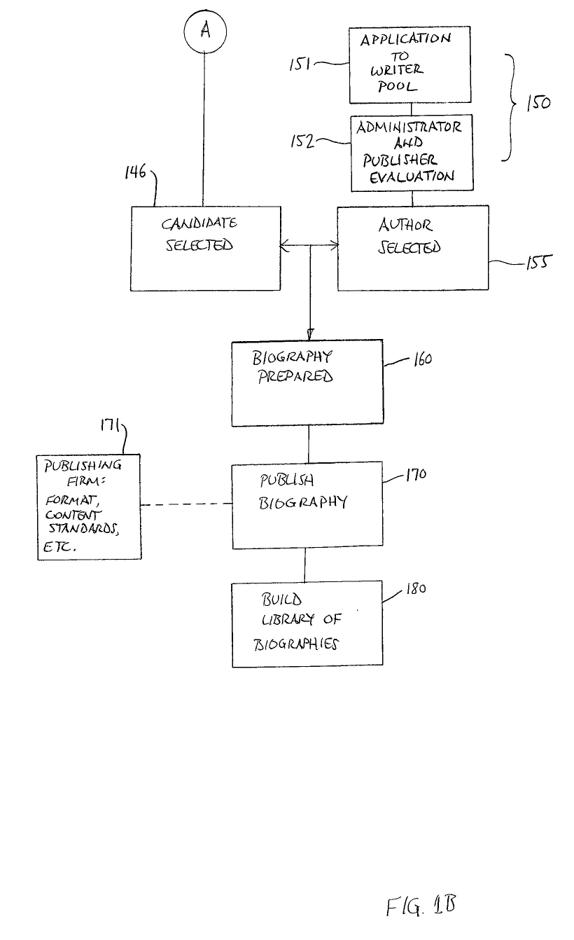

A process for selecting a candidate for a biographical work is shown schematically in FIGS. 1A and 1B, which are to be read as connected flowcharts.

A user of the main service website nominates an individual (the “candidate”) for consideration as a subject of a biography (step 110). The main service website provides a detailed questionnaire for users who wish to nominate a candidate. After the completed questionnaire is submitted through the web site (step 120), the profile is reviewed by the site administrator (typically a committee) and the individual is listed as a candidate (step 130). A review and evaluation process is then initiated to consider data (“lifetime valuation data”) associated with each candidate.

The candidate selection process 140 includes gathering information to validate the profile submitted by the nominator (step 141); communicating with various individuals, typically including the nominator, the candidate, and others, including those who may know and have input regarding the candidate (step 142); allowing viewers of the website to access the questionnaire (step 143); and inviting the viewers to vote, rank, compare or determine viewer perception on the comparative qualities of the candidates (step 144). It may be possible to include other methods of voting or ranking such as calling in by phone, emailing, texting, submitting written votes through the mail, and the like. These will be recorded and entered into the system as well. In general, a variety of voting metrics will be associated with submittals and postings to the web site.

The lifetime valuation data associated with a given individual may be represented using parameters or variables assigned to various stages or events of the individual's life. For example, each parameter may be assigned a value (alpha or numeric), representing a different characteristic or life value. In an embodiment, calculation of a “Life Quality Valuation” is then performed using a predetermined formula and the parameter values (step 145). A large number of life values may be reviewed independently in the candidate review and evaluation process.

In an embodiment, biographies are produced at a planned frequency rate, which may vary and will be determined based on the candidate volume and activity within each of the candidate categories. Based on the Life Quality Valuation and review, the candidate having the highest valuation (that is, the highest ranking of the nominated candidates in the relevant time period) is selected as the biographical subject (step 146).

The main service website may also include text- or video-based testimonials on behalf of a candidate, and may also provide a petition procedure as part of the validation process.

The candidate selection process will generally include communications, conversations, and/or visits between members of a reviewing committee (appointed by the site administrator) and the candidate and those submitting nominations or inputs on their behalf These communications will typically include phone discussions, face to face visits and/or web audio/video conferencing 172. Preferably there will also be direct contact between the reviewers and persons who know the candidate, particularly persons who have submitted testimonials to the main service website. Details of the selection process may vary depending on life quality values, votes, ranking, committee assessment, and the like, although the overall concept and process remains consistent.

A selection process 150 is also followed for the author of the projected biography. In an embodiment, prospective authors submit applications to the publisher (step 151) to be included in a pool of writers. The site administrator cooperates with the publisher to evaluate the writers (step 152), and select an author (step 155) to be assigned to each selected candidate. Alternatively, the authors themselves may select their preferences based on an established process of reviewing the nominations, conducting interviews, and so forth.

In another embodiment, prospective new authors may also submit applications through the main service website to join the network pool of authors who will write the biographies. The applications are reviewed by the site administrator and publisher for consideration to be included as part of the writer pool.

Upon assignment of an author to a selected candidate, the author begins to prepare a biography (step 160). In an embodiment, the biography is published (step 170) in accordance with an arrangement between the web site administrator and a publishing firm 171. A number of biographies produced in this fashion may then be recognized as belonging to a library (step 180) associated with the main service website.

In preparing the biography, the writer will include any data (from visits, calls, conversations, video conferences, and the like) necessary to capture the details needed for the biography. Typically, at least some of this data has been already submitted to the main service website. The length of the literary work will vary, but it will generally be an abridged version compared to a typical biography of a famous individual. Ideally, the author will capture the essence of why the individual is an OP/EL, but will not over-detail the person's life. Due to the nature of the literary series, it is desirable that the length of each work is limited; readers should be intrigued to follow the series of biographies, and not be discouraged by works that may be too lengthy. The literary works criteria (such as approximate number of pages and/or words) will be determined and shared with the authors to maintain consistency with the series and process. The literary works may also contain pictures, icons, pictorials, or other highlights and aids relevant to the individual subjects.

As the biographies are published, they preferably will share a headline and banner name, follow titling protocols, with the subtitles that directly or indirectly identifies and exemplifies the particular individual who is the subject of a given work. There may also be registered slogans, tag lines and/or pictorial representation used for the output product series. The web site administrator may derive revenue from the sale of the biography (through various media) by arrangement with the publisher. The administrator will determine through the process which selections and material will make it through to full publication and distribution and which will be limited to the web site. The website may also contain general information and stories outside of the literary submittal and selection process.

The published biographies (which represent the output of the above-described process) may be released in traditional hard copy form or electronically. The works may be distributed by any of a variety of different methods, including:

Traditional hard copy publishing, such as paperback or hard cover

Publishing on demand (POD), whereby requests are taken through the web site and publications made through an online POD supplier based on the requests received

Direct to e-book publishing, whereby requests are fulfilled only through an e-book option

Distribution through periodicals, journals, magazines, or the like

In alternative embodiments, the biographical literary works created from, or in association with, the main service website may be presented in digital audio format such as .wav, .avi, .mp3, .mp4, .wma, etc. whereby the audio files or audio books may be accessible or downloadable from the main service website, or on a DVD or other suitable media.

The main service website may allow users to join a membership club for the specific purpose of allowing them to receive the continuing series of the completed outputs in any selected category and in any of the publishing formats or product outputs described above.

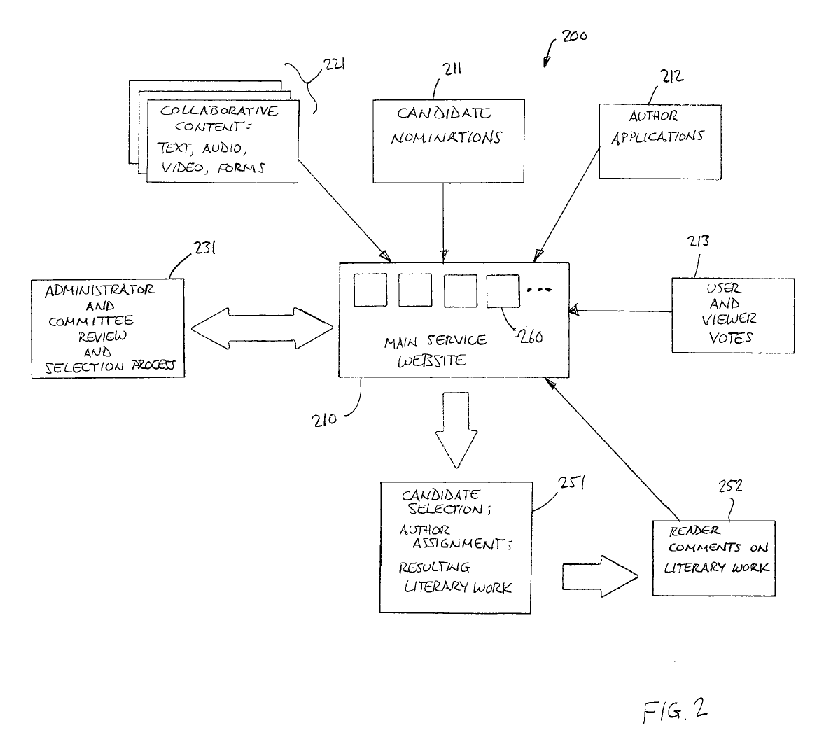

A schematic illustration of a system 200 for performing the above-described method, including a main service website according to the disclosure (with associated content, user inputs, and literary product) is shown in FIG. 2. Main service website 210 has as inputs candidate nominations 211; author applications 212; various forms of content 221 representing data regarding candidates; and user/viewer votes or ranking 213. Throughout the candidate selection process, the site administrator and candidate reviewing committee communicate with each other (shown schematically at 231) via the site 210 or other means. The web site will maintain various levels of access by users, authors, committee members, and the like based on their roles and system business rules. The results of the above-described processes (shown schematically at 251) include the selection of a candidate as a subject of a biography; the assignment of an author to produce the literary work; and ultimately the literary work itself. The website will also advantageously include an area for readers' input and comments 252 regarding the resulting biographies, to document reader preferences.

Special categorical sections 260 of the main service website 210 may be devoted to particular situations or biographical categories, such as the following:

A candidate may be nominated by an aspiring author, who will likely be already well acquainted with the individual he seeks to write about. This would be a case of “ordinary people telling the stories of ordinary people.”

A candidate may seek to write an autobiography.

Children may be encouraged to become authors, with children of various age groups preparing biographies of individuals who have impacted their lives. In another variation, stories and biographies are prepared by adults towards children of different age groups for their reading.

Nominations of deceased individuals may be offered by their families and friends, who are then encouraged to submit their reminiscences.

Biographies of individuals with disabilities, illnesses or other hardships that have left a lasting impression on those around them by persevering and overcoming their challenges.

Biographies of individuals who are known to have made an impact on their home communities.

Nominations of a pair of individuals, such as a couple married for many years, focusing on their life together.

Individuals who have led the type of fascinating and captivating lives which readers would find of interest.

Individuals who have encountered life changing experiences that readers would find intriguing.

International variations of the process, including languages other than English.

It will be appreciated that since there are multiple categories within the main service website, separate processes for nomination, voting, candidate selection, author selection and resulting literary work may be ongoing simultaneously for each of the various categories. Accordingly, a selection process may occur continuously at the main service website in one category or another. In a voting process, candidates are compared with other candidates within the same category. A candidate that is not selected may continue to be part of a candidate pool for a subsequent voting process within that category for a future biography. Each category may thus have an ongoing selection process.

In another embodiment, interested parties may license the rights for the biographies to be written for their candidates or themselves, rather than going through the selection process or where they are not selected as part of the process. In this case, the arrangement might be for personal distribution and not for general distribution, whereby the interested parties will license for a set number of product output publications.

In other embodiments, several individual biographies may be shortened, collected and reissued as a compilation of stories on a particular topic (for example, one of the variations or categories mentioned above). The biographies may also be distributed through a variety of channels (e.g. new or established periodicals or journals as noted), or transformed into other types of media such as television, cable, or radio.

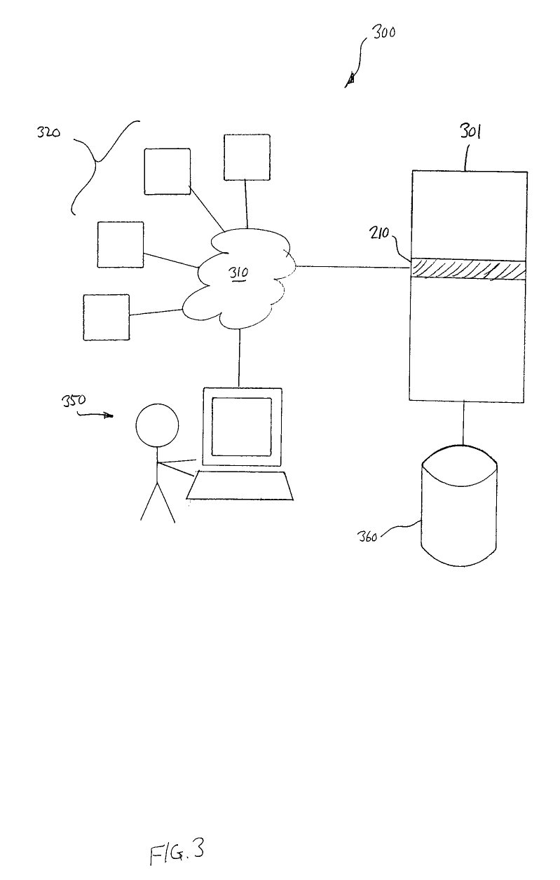

The system shown schematically at 200 may be realized using an arrangement 300 in which a server 301 is connected to the Internet 310, as shown in FIG. 3. Server 301 hosts main service website 210. Various users and visitors 320 (including the nominator, candidate, and voters), along with author 350, interact with and contribute to site 210 via the Internet. Users 320 and author 350 may communicate with, and navigate in, the web site (inputting and extracting data) by a variety of methods, including using a computer keyboard, a mouse, a mobile device, a touch screen interface, a microphone with voice recognition software, and so forth. It should be noted that the system administrator is able to communicate with the candidate and the author via the Internet at all stages of the biography production process. The data collected during the candidate selection process and during the writing process may be stored in storage unit 360 coupled to server 301; alternatively, this storage may be at a more remote location and accessed through the Internet.

The process described herein may be extended beyond the biographical process to include other genres. For example, a visitor to the website may nominate a particular theme or subject that he would like to see written about. If the subject has sufficient appeal, based on other visitors' votes, then the publisher and administrator may decide to engage a writer to produce a work on that subject.

While the disclosure has been described in terms of specific embodiments, it is evident in view of the foregoing description that numerous alternatives, modifications and variations will be apparent to those skilled in the art. Accordingly, the disclosure is intended to encompass all such alternatives, modifications and variations which fall within the scope and spirit of the disclosure and the following claims.

I claim:

1. A method for facilitating preparation of a literary work, the method being performed using a web site dedicated thereto, the web site hosted on a computer server, the method comprising the steps of:
receiving a nomination of a potential biographical subject from a user via the web site;
transmitting to the user making the nomination a profile questionnaire for obtaining information regarding the nominee;
receiving the questionnaire with said information;
collecting additional information regarding the nominee from additional users;
facilitating communication among a plurality of users, thereby collecting further information regarding the nominee;
evaluating suitability of the nominee as a subject of a literary work;
selecting a nominee as the subject; and
causing an author to be assigned to the subject to prepare the literary work.

2. The method of claim 1, wherein said evaluating step further comprises calculating a Life Quality Valuation (LQV) based on the collected information.

3. The method of claim 2, wherein said selecting step further comprises selecting the subject within one category of a plurality of categories from a plurality of nominees in accordance with a ranking of LQV results for the respective nominees in said category.

4. The method of claim 1, wherein said selecting step further comprises conducting a vote, ranking, and/or comparison regarding nominees by users of the website.

5. The method of claim 1, wherein said step of causing an author to be assigned further comprises performing an author selection process in which potential authors are evaluated by at least one of an administrator of the web site and a publisher of the literary work.

6. The method of claim 5, wherein the author selection process further comprises receiving applications from potential authors for inclusion in a pool from which the assigned author is selected.

7. The method of claim 1, further comprising the step of publishing the literary work by offering the literary work from the web site.

8. The method of claim 7, wherein offering the literary work comprises at least one of: receiving orders for hard copies of the literary work; offering the literary work for sale via a download from the website; offering the literary work for sale in a digital audio format; receiving a publishing on demand (POD) request; and receiving an e-book publishing request.

9. The method of claim 1, further comprising the step of preparing and publishing a plurality of literary works, wherein the works are identified as belonging to a library associated with the web site.

10. A system for facilitating preparation of a literary work, comprising:
a server for hosting a web site, the server configured to transmit and receive content from users via a connection to the Internet,
the content including
a nomination of a candidate biographical subject,
biographical data of the candidate,
evaluations of the candidate based on said data,
an application from a potential author for inclusion in a pool of authors, and
a biography of the candidate selected as the biographical subject, prepared by an author selected from the pool of authors.

11. The system of claim 10, wherein the server is configured to conduct via the website a vote, ranking, and/or comparison by the users regarding whether a candidate is to be selected as the biographical subject.

12. The system of claim 10, wherein the server is configured to calculate a Life Quality Valuation regarding a candidate using a predetermined formula.

13. The system of claim 10, further comprising a storage unit, coupled to the server, for storing the biographical data and the literary work.

14. The system of claim 10, wherein the server is configured to publish the literary work as content on the web site.

15. The system of claim 14, wherein the server is configured to present the literary work in a digital audio format.

16. A computer-readable medium have stored therein instructions for performing a method for facilitating preparation of a literary work using a web site, the method comprising the steps of:
receiving a nomination of a potential biographical subject from a user via the web site;
transmitting to the user making the nomination a profile questionnaire for obtaining information regarding the nominee;
receiving the questionnaire with said information;
collecting additional information regarding the nominee from additional users;
facilitating communication among a plurality of users, thereby collecting further information regarding the nominee;
evaluating suitability of the nominee as a subject of a literary work;
selecting a nominee as the subject; and
causing an author to be assigned to the subject to prepare the literary work.

17. The computer-readable medium of claim 16, wherein said evaluating further comprises calculating a Life Quality Valuation (LQV) based on the collected information.

18. The computer-readable medium of claim 16, wherein said selecting further comprises selecting the subject from a plurality of nominees in accordance with a ranking of LQV results for the respective nominees.

19. The computer-readable medium of claim 16, wherein said selecting further comprises conducting a vote, ranking, and/or comparison by users of the website.

20. The computer-readable medium of claim 16, wherein the method further comprises publishing the literary work by offering the work from the web site.
